(19) United States
(12) Patent Application Publication
(10) Pub. No.: US 2024/0276407 A1
(43) Pub. Date: Aug. 15, 2024

(54) METHOD AND APPARATUS FOR MAINTENANCE OF UPLINK TIME ALIGNMENT

(71) Applicant: FUJITSU LIMITED, Kawasaki-shi Kanagawa (JP)

(72) Inventors: Meiyi JIA, Beijing (CN); Zhe CHEN, Beijing (CN)

(73) Assignee: FUJITSU LIMITED, Kawasaki-shi Kanagawa (JP)

(21) Appl. No.: 18/636,517

(22) Filed: Apr. 16, 2024

Related U.S. Application Data
(63) Continuation of application No. PCT/CN2021/124799, filed on Oct. 19, 2021.

(51) Int. Cl. H04W 56/00; H04W 84/04

(52) U.S. Cl. CPC H04W 56/001; H04W 84/047

(57) ABSTRACT

A method and apparatus for maintenance of uplink time alignment. The method includes: a terminal equipment receives configuration information of a timing advance group (TAG) identifier configured by a network device for a serving cell and/or an intermediate device (node/entity); and controls how long a media access control (MAC) entity considers a serving cell and/or an intermediate device belonging to a timing advance group (TAG) associated with the timing advance group identifier to be uplink time aligned.

### CROSS-REFERENCE TO RELATED APPLICATION

This application is a continuation application of International Application PCT/CN2021/124799, filed on Oct. 19, 2021, and designated the U.S., the entire contents of which are incorporated herein by reference.

### FIELD

This disclosure relates to the field of communication technologies.

### BACKGROUND

In an RRC (radio resource control) connected state, a network device (gNB) is responsible for maintaining timing advance (TA) to maintain L1 synchronization. Serving cells with identical ULs (uplinks) applicable to TA and using identical timing reference cells are grouped in one TAG (timing advance group). Each TAG includes at least one serving cell configured with an uplink, and RRC configures mapping from each serving cell to one TAG.

For a primary TAG, a user equipment (UE) uses a PCell (primary cell) as a timing reference, and in addition to shared frequency channel access, an SCell (secondary cell) may also be used in some cases. In a secondary TAG, the UE may possibly use any active secondary cell in this TAG as a timing reference cell, but it is not changed unless necessary.

TA update is notified to the UE by the gNB via MAC CE (media access control control element) commands. These commands restart a TAG-specific timer indicating L1 synchronization or asynchronization/out of synchronization, i.e. when the timer is running, L1 synchronization is deemed, otherwise L1 asynchronization is deemed. In a case of L1 asynchronization, uplink transmission may only be transmitted via MSG1/MSGA (message 1/message A).

Usually, RRC configures timeAlignmentTimer (per TAG) to maintain UL time alignment and control how long a MAC entity considers a serving cell belonging to an associated TAG to be uplink time aligned.

When a TAC (timing advance command) MAC CE is received and if a designated TAG has already maintained an N_{TA}, the MAC entity will start or restart timeAlignmentTimer associated with the designated TAG.

When a TAC is received in a random access response (RAR) message of a serving cell belonging to a TAG or an MSGB of a special cell, if a random access preamble is not selected by a MAC entity from contention-based random access preambles, the MAC entity will start or restart timeAlignmentTimer associated with the TAG; otherwise, if timeAlignmentTimer associated with the TAG is not running, timeAlignmentTimer associated with the TAG is started, and timeAlignmentTimer of the TAG is stopped when it is deemed that contention resolution is not successful or after transmitting HARQ feedback of an MAC PDU of an MAC CE including a UE contention resolution ID and when it is deemed that contention resolution requested by SI is successful; otherwise, the received TAC is ignored.

When an absolute timing advance command in response to MSGA transmission including a C-RNTI MAC CE is received, the MAC entity will start or restart timeAlignmentTimer associated with a PTAG (primary TAG).

When a timeAlignmentTimer expires:
if the timeAlignmentTimer is associated with a PTAG, the MAC entity will: flush all HARQ buffers of all serving cells; notify RRC to release PUCCHs (if configured) of all serving cells; notify RRC to release SRSs (if configured) of all serving cells; clear all configured downlink allocations and configured uplink grants; clear all PUSCH resources for semi-persistent CSI reporting; deem that all running timeAlignmentTimer expires; and maintain NTA of all TAGs.

Otherwise, if the timeAlignmentTimer is associated with an STAG (secondary TAG), for all serving cells belonging to the TAG, the MAC entity will: flush all HARQ buffers; notify RRC to release PUCCHs (if configured); notify RRC to release SRSs (if configured); clear all configured downlink allocations and configured uplink grants; clear all PUSCH resources for semi-persistent CSI reporting; and maintain the NTA of the TAG.

When the MAC entity stops uplink transmission of an SCell due to exceeding a maximum uplink transmission time difference between TAGs of the MAC entity or exceeding a maximum uplink transmission time difference between TAGs of any MAC entity of the U, the MAC entity deems that timeAlignmentTimer associated with the SCell expires.

In order to achieve maintenance of uplink time alignment, RRC uses IE MAC-CellGroupConfig to configure MAC parameters of a cell group, including configuration of a TAG, which invokes IE TAG-Config to indicate a tag-Id and corresponding timeAlignmentTimer. In addition, IE ServingCellConfig is used to configure (add or modify) a serving cell, including the tag-Id, for the UL.

Table 1 below shows IE MAC-CellGroupConfig.

TABLE 1
-- ASN1START
-- TAG-MAC-CELLGROUPCONFIG-START
MAC-CellGroupConfig ::= SEQUENCE {

| drx-Config | SetupRelease { DRX-Config } | OPTIONAL, -- Need M |
|---|---|---|
| schedulingRequestConfig SchedulingRequestConfig | | OPTIONAL, -- Need M |
| bsr-Config | BSR-Config | OPTIONAL, -- Need M |
| tag-Config | TAG-Config | OPTIONAL, -- Need M |
| phr-Config | SetupRelease { PHR-Config } | OPTIONAL, -- Need M |

| | |
|---|---|
| skipUplinkTxDynamic | BOOLEAN, |

```
  ...,
  [[
```

| | | |
|---|---|---|
| csi-Mask | BOOLEAN | OPTIONAL, -- Need M |
| dataInactivityTimer | SetupRelease { DataInactivityTimer } | OPTIONAL -- Cond |

```
MCG-Only
  ]],
  [[
```

| | | |
|---|---|---|
| usePreBSR-r16 | ENUMERATED {true} | OPTIONAL, -- Need R |
| schedulingRequestID-LBT-SCell-r16 | SchedulingRequestId | OPTIONAL, -- Need R |
| lch-BasedPrioritization-r16 | ENUMERATED {enabled} | OPTIONAL, -- Need R |
| schedulingRequestID-BFR-SCell-r16 | SchedulingRequestId | OPTIONAL, -- Need R |

| | |
|---|---|
| drx-ConfigSecondaryGroup-r16 | SetupRelease { DRX-ConfigSecondaryGroup } |

```
OPTIONAL -- Need M
  ]],
  [[
```

| | | |
|---|---|---|
| enhancedSkipUplinkTxDynamic-r16 | ENUMERATED {true} | OPTIONAL, -- |

Need R

| | | |
|---|---|---|
| enhancedSkipUplinkTxConfigured-r16 | ENUMERATED {true} | OPTIONAL -- |

Need R
]]
}

| | |
|---|---|
| DataInactivityTimer ::= | ENUMERATED {s1, s2, s3, s5, s7, s10, s15, s20, s40, s50, s60, s80, |

s100, s120, s150, s180}
-- TAG-MAC-CELLGROUPCONFIG-STOP
-- ASN1STOP

Table 2 below shows filed descriptions of IE MAC-CellGroupConfig.

TABLE 2
MAC-CellGroupConfig field descriptions
usePreBSR
If set to true, the MAC entity of the IAB-MT may
use the Pre-emptive BSR, see TS 38.321 [3].
csi-Mask
If set to true, the UE limits CSI reports to the on-duration
period of the DRX cycle, see TS 38.321 [3].
dataInactivity Timer
Releases the RRC connection upon data inactivity as
designated in clause 5.3.8.5 and in TS 38.321
[3]. Value s1 corresponds to 1 second,
value s2 corresponds to 2 seconds, and so on.
drx-Config
Used to configure DRX as designated in TS 38.321 [3].
drx-ConfigSecondaryGroup
Used to configure DRX related parameters for the
second DRX group as designated in TS 38.321 [3].
The network does not configure secondary DRX
group with DCP simultaneously nor secondary
DRX group with a dormant BWP simultaneously.
Ich-BasedPrioritization
If this field is present, the corresponding MAC entity
of the UE is configured with prioritization
between overlapping grants and between scheduling
request and overlapping grants based on LCH
priority, see TS 38.321 [3].
schedulingRequestID-BFR-SCell
Indicates the scheduling request configuration
applicable for BFR on SCell, as designated in TS
38.321 [3].
schedulingRequestID-LBT-SCell
Indicates the scheduling request configuration
applicable for consistent uplink LBT recovery on
SCell, as designated in TS 38.321 [3].
skipUplinkTxDynamic, enhancedSkipUplinkTxDynamic,
enhancedSkipUplinkTxConfigured
If set to true, the UE skips UL
transmissions as described in TS 38.321 [3].
tag-Config
The field is used to configure parameters for a
time-alignment group. The field is not present if any
DAPS bearer is configured.

Explanations of MCG-Only are as shown in Table 3.

TABLE 3

| Conditional Presence | Explanation |
|---|---|
| MCG-Only | This field is optionally present, Need |
| | M, for the MAC-CellGroupConfig of |
| | the MCG. It is absent otherwise. |

Table 4 below shows IE TAG-Config.

TABLE 4
-- ASN1START
-- TAG-TAG-CONFIG-START

| | |
|---|---|
| TAG-Config ::= | SEQUENCE { |
| tag-ToReleaseList | SEQUENCE (SIZE (1..maxNrofTAGs)) OF TAG-Id OPTIONAL, -- |

Need N

| | |
|---|---|
| tag-ToAddModList | SEQUENCE (SIZE (1..maxNrofTAGs)) OF TAG OPTIONAL |

-- Need N
}

| | |
|---|---|
| TAG ::= | SEQUENCE { |
| tag-Id | TAG-Id, |
| timeAlignmentTimer | TimeAlignmentTimer, |

...
}

| | |
|---|---|
| TAG-Id ::= | INTEGER (0..maxNrofTAGs-1) |
| TimeAlignmentTimer ::= | ENUMERATED {ms500, ms750, ms1280, ms1920, ms2560, |

ms5120, ms10240, infinity}
-- TAG-TAG-CONFIG-STOP
-- ASN1STOP

Table 5 below shows filed descriptions of a TAG.

TABLE 5
TAG field descriptions
tag-Id
Indicates the TAG of the SpCell or an SCell, see
TS 38.321 [3]. Uniquely identifies the TAG within
the scope of a Cell Group (i.e. MCG or SCG).
timeAlignmentTimer
Value in ms of the timeAlignmentTimer for TAG
with ID tag-Id, as designated in TS 38.321 [3].

Table 6 below shows IE ServingCellConfig.

TABLE 6
-- ASN1START
-- TAG-SERVINGCELLCONFIG-START
ServingCellConfig ::= SEQUENCE {

| | | |
|---|---|---|
| tdd-UL-DL-ConfigurationDedicated | TDD-UL-DL-ConfigDedicated | OPTIONAL, -- |

Cond TDD

| | | |
|---|---|---|
| initialDownlinkBWP | BWP-DownlinkDedicated | OPTIONAL, -- Need |

```
M
  downlinkBWP-ToReleaseList SEQUENCE (SIZE (1..maxNrofBWPs)) OF BWP-Id OPTIONAL,
-- Need N
  downlinkBWP-ToAddModList SEQUENCE (SIZE (1..maxNrofBWPs)) OF BWP-Downlink
OPTIONAL, -- Need N
```

| | | |
|---|---|---|
| firstActiveDownlinkBWP-Id | BWP-Id | OPTIONAL, -- Cond |

SyncAndCellAdd

| | |
|---|---|
| bwp-InactivityTimer | ENUMERATED {ms2, ms3, ms4, ms5, ms6, ms8, ms10, ms20, |

ms30,

```
      ms40,ms50, ms60, ms80,ms100, ms200,ms300, ms500,
  ms750, ms1280, ms1920, ms2560, spare10, spare9, spare8,
  spare7, spare6, spare5, spare4, spare3, spare2, spare1 }
```

OPTIONAL, --Need R

| | | |
|---|---|---|
| defaultDownlinkBWP-Id | BWP-Id | OPTIONAL, -- Need S |
| uplinkConfig | UplinkConfig | OPTIONAL, -- Need M |
| supplementaryUplink | UplinkConfig | OPTIONAL, -- Need M |

| | |
|---|---|
| pdcch-ServingCellConfig | SetupRelease { PDCCH-ServingCellConfig } OPTIONAL, -- |

Need M

| | |
|---|---|
| pdsch-ServingCellConfig | SetupRelease { PDSCH-ServingCellConfig } OPTIONAL, -- Need |

M

| | | |
|---|---|---|
| csi-MeasConfig | SetupRelease { CSI-MeasConfig } | OPTIONAL, -- Need M |

| | |
|---|---|
| sCellDeactivationTimer | ENUMERATED {ms20, ms40, ms80, ms160, ms200, |

ms240,

```
        ms320, ms400, ms480, ms520, ms640, ms720,
        ms840, ms1280, spare2,spare1}
```

OPTIONAL, -- Cond ServingCellWithoutPUCCH

| | | |
|---|---|---|
| crossCarrierSchedulingConfig | CrossCarrierSchedulingConfig | OPTIONAL, -- Need M |

| | |
|---|---|
| tag-Id | TAG-Id, |

... ...

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that in the current NR (New Radio), operations of two TRPs are supported, including two scenarios: 1) two TRPs belong to identical cells; and 2) two TRPs belong to different cells, one is a serving cell, and the other is a cell with different PCIs. For scenario 1), different TRPs belong to identical TAGs, and a terminal maintains a timeAlignmentTimer, that is, all TRP synchronization/asynchronization states are identical and a TAC is applicable to timing adjustment of uplink transmission of all TRPs; and for scenario 2), it has not yet been discussed. On the other hand, in a scenario of a repeater, it is not distinguished whether a terminal communicates with a network device via the repeater, that is, reaching the network device via the repeater and directly reaching the network device via no repeater belong to identical TAGs, and synchronization states thereof are consistent.

Therefore, in a case of operating using additional nodes/devices/entities (such as TRPs/repeaters), following problems exist in existing techniques, that is, uplink synchronization/asynchronization states with or without additional nodes/devices/entities are identical, and a TAC is applicable to timing adjustment of all uplink transmissions with or without additional nodes/devices/entities:
1) frequencies used by different additional nodes/devices/entities may be different, for example, one TRP operates at FR1 to provide coverage for a terminal, while another TRP operates at FR2 to provide broadband services for the terminal; or, positions of different additional nodes/devices/entities are different, that is, the transmission paths between the terminal and different additional nodes/devices/entities are different; in this case, UL transmissions of the terminal at different additional nodes/devices/entities may exceed a maximum uplink transmission time difference, and thus uplink transmission of an additional node/device/entity may stop. This will result in that the network is unable to provide sufficient bandwidth for the terminal;
2) L1 synchronization/asynchronization states determined by a timer are not in consistent with actual synchronization states of UL transmissions via the additional nodes/devices/entities, thereby resulting in interference, decoding failure, and service interruption.

In order to solve at least one of the above problems, embodiments of this disclosure provide a method and apparatus for maintenance of uplink time alignment.

According to an aspect of the embodiments of this disclosure, there is provided an apparatus for maintenance of uplink time alignment, configured in a terminal equipment, the apparatus including:
a receiving unit configured to receive configuration information of a timing advance group (TAG) identifier configured by a network device for a serving cell and/or an intermediate device (node/entity); and
a control unit configured to control how long the MAC entity considers a serving cell and/or an intermediate device belonging to a timing advance group (TAG) associated with the timing advance group identifier to be uplink time aligned.

According to another aspect of the embodiments of this disclosure, there is provided an apparatus for maintenance of uplink time alignment, configured in a network device, the apparatus including:
a configuring unit configured to configure a timing advance group (TAG) identifier for a serving cell and/or an intermediate device (node/entity), the TAG identifier being used to acknowledge a timing advance group of a terminal equipment;
wherein the terminal equipment uses a timer to control how long a media access control (MAC) entity considers a serving cell and/or an intermediate device belonging to a timing advance group (TAG) associated with the timer to be uplink time aligned.

According to a further aspect of the embodiments of this disclosure, there is provided a communication system, including a terminal equipment, an intermediate device and a network device, wherein,
the terminal equipment receives configuration information of a timing advance group (TAG) identifier configured by the network device for a serving cell and/or an intermediate device (node/entity), and controls how long a media access control (MAC) entity considers a serving cells and/or an intermediate device belonging to a timing advance group (TAG) associated with the timing advance group identifier to be uplink time aligned, and/or
the network device configures a timing advance group (TAG) identifier for a serving cell and/or an intermediate device (node/entity), the TAG identifier being used to acknowledge a timing advance group of a terminal equipment, and the terminal equipment uses a timer to control how long a media access control (MAC) entity considers a serving cell and/or an intermediate device belonging to a timing advance group (TAG) associated with the timer to be uplink time aligned.

An advantage of the embodiments of this disclosure exists in that for the uplink transmission transmitted by the terminal via additional nodes/devices/entities with operating frequencies or deployment locations different from those of the network device, a separate uplink synchronization state is maintained, so as to avoid stop of uplink transmission due to that the UL transmission of the terminal at different additional nodes/devices/entities exceeds a maximum uplink transmission time difference, and avoid interference on the network device.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in identical way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is schematic diagram of a deployment scenario of a repeater/RIS;

FIG. 2 is a schematic diagram of multi-TRP operations;

FIG. 3 is a schematic diagram of the method for maintenance of uplink time alignment of an embodiment of a first aspect of this disclosure;

FIG. 4 is a schematic diagram of the method for maintenance of uplink time alignment of an embodiment of a second aspect of this disclosure;

FIG. 5 is a schematic diagram of the apparatus for maintenance of uplink time alignment of an embodiment of a third aspect of this disclosure;

FIG. 6 is a schematic diagram of the apparatus for maintenance of uplink time alignment of an embodiment of a fourth aspect of this disclosure;

FIG. 7 is a schematic diagram of the communication system of an embodiment of this disclosure;

FIG. 8 is a schematic diagram of the terminal equipment of an embodiment of this disclosure; and

FIG. 9 is a schematic diagram of the network device of an embodiment of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except designated otherwise. Furthermore, the term “according to” should be understood as “at least partially according to”, the term “based on” should be understood as “at least partially based on”, except designated otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G and 5G and new radio (NR) in the future, etc., and/or other communication protocols that are currently known or will be developed in the future.

In the embodiments of this disclosure, the term “network device”, for example, refers to a device in a communication system that accesses a terminal equipment to the communication network and provides services for the terminal equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.), an IAB (Integrated Access and Backhaul) node or IAB-DU or IAB-donor. The term “base station” may include some or all of its functions, and each base station may provide communication coverage for a specific geographical area. And a term “cell” may refer to a base station and/or its coverage area, depending on a context of the term. The terms “cell” and “base station” can be interchanged without causing confusion.

In the embodiments of this disclosure, the term “user equipment (UE)” or “terminal equipment (TE) or terminal device” refers to, for example, an equipment accessing to a communication network and receiving network services via a network device. The terminal equipment may be fixed or mobile, and may also be referred to as a mobile station (MS), a terminal, a subscriber station (SS), an access terminal (AT), IAB-MT, or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station, and may include one or more network devices described above. The term “user side” or “terminal side” or “terminal equipment side” refers to a side of a user or a terminal, which may be a UE, and may include one or more terminal equipments described above. “Device” may refer to a network device, or may refer to a terminal equipment.

In an existing communication system, in order to increase coverage, an additional node/device/entity is added between a network device (such as a gNB or a gNB-CU) and a terminal, which has a simplified protocol stack/function for processing (such as amplifying, and routing, etc.) signals/symbols received from the network device and transferring them to the terminal. The additional node/device/entity may be a repeater/RIS (reconfigurable intelligent surface), or may be a TRP, etc. For the convenience of explanation, in the embodiments of this disclosure, the additional nodes/devices/entities are collectively referred to as intermediate devices. However, this disclosure is not limited thereto, and all scenarios where an additional node/device/entity is/are used between the network device and the terminal are scenarios of the embodiments of this disclosure.

Scenarios of the embodiments of this disclosure shall be described below by way of examples; however, this disclosure is not limited thereto.

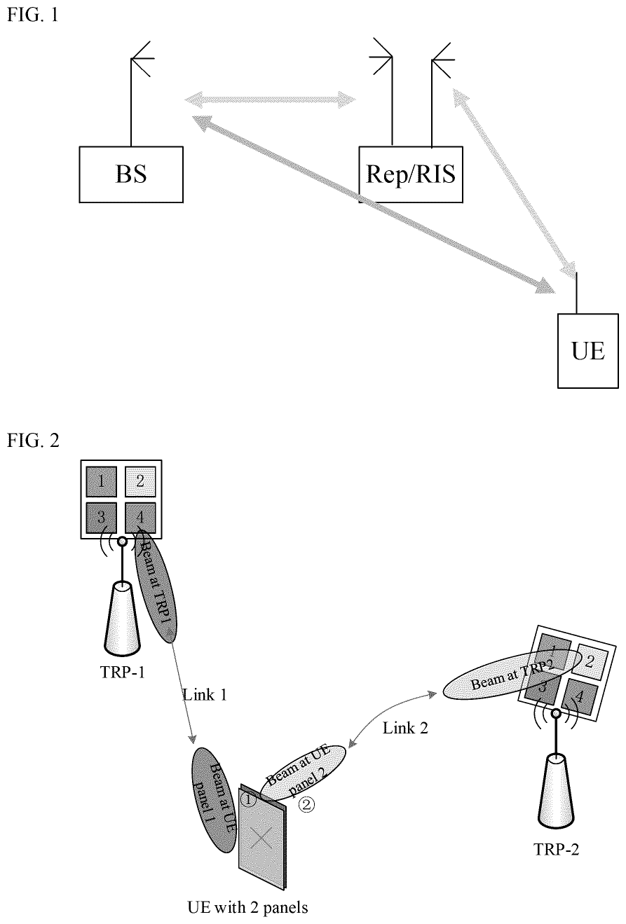

FIG. 1 is schematic diagram of a deployment scenario of a repeater/RIS. As shown in FIG. 1, repeater/RIS is a device that receives, processes and transmits radiated or conducted RF carriers in a downlink direction (from a network device BS to a terminal UE) and an uplink direction (from the terminal UE to the network device BS). For the repeater, the processing includes power amplification; and for the RIS, the processing includes beamforming, reshaping a propagation environment, etc. In a working frequency band where only downlink or uplink is designated, only the designated uplink or downlink transmission is repeated.

FIG. 2 is a schematic diagram of multi-TRP operations. A TRP is a part of a network device and is used to receive signals from or transmit signals to a terminal UE.

As shown in FIG. 2, in multi-TRP operations, a serving cell may schedule the UE from two TRPs, providing better PDSCH coverage, reliability and/or data rates. For multi-TRP, there are two different operating modes, namely, single-DCI and multi-DCI. For these two modes, within configuration provided by an RRC layer, control of uplink and downlink operations is performed by a physical layer and a MAC layer. In the single-DCI mode, the UE is scheduled by two TRPs via identical DCIs, and in the multi-DCI mode, the UE is scheduled by separate DCI of each TRP. These two TRPs may belong to identical cells or different cells.

As shown in FIG. 2, a gNB where TRP-2 is located is an additional node/device/entity, while a gNB where TRP-1 is located is a network device. TRP-2 and TRP-1 may belong to different gNBs or different cells of different gNBs, and the two may exchange information via an X2 interface; or, TRP-2 and TRP-1 may be parts of a gNB, belong to identical gNBs or identical or different cells of identical gNB, and exchange information via an internal interface.

The embodiments of this disclosure shall be described below with reference to the accompanying drawings and implementations, and identical expressions therein having identical meanings, which shall not be repeated herein any further.

### Embodiment of a First Aspect

The embodiment of this disclosure provides a method for maintenance of uplink time alignment, which shall be described from a terminal equipment.

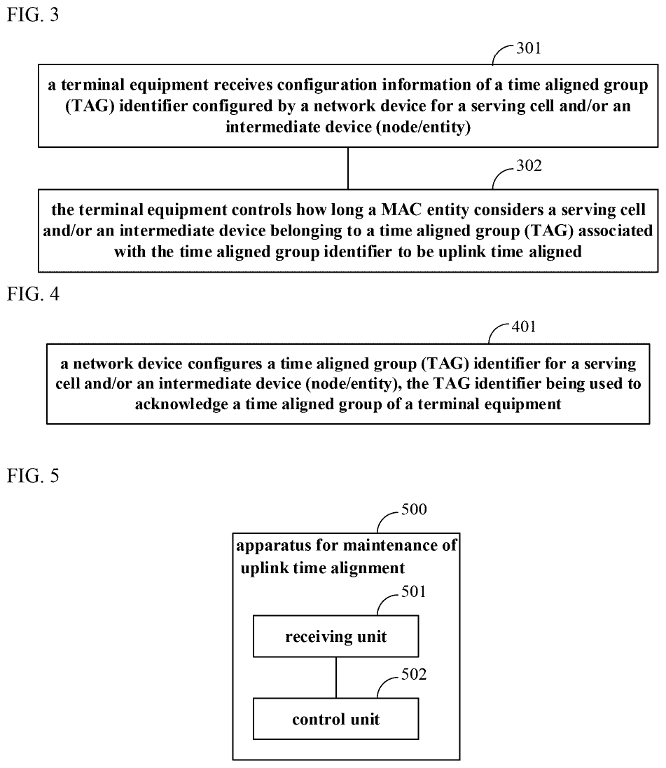

FIG. 3 is a schematic diagram of the method for maintenance of uplink time alignment of the embodiment of this disclosure. As shown in FIG. 3, the method includes:
301: a terminal equipment receives configuration information of a timing advance group (TAG) identifier configured by a network device for a serving cell and/or an intermediate device (node/entity); and
302: the terminal equipment controls how long a MAC entity considers a serving cell and/or an intermediate device belonging to a timing advance group (TAG) associated with the timing advance group identifier to be uplink time aligned.

It should be noted that FIG. 3 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 3.

In the above embodiment, the network device configures the TAG identifier for the serving cell and/or intermediate device, and the terminal equipment controls how long the MAC entity considers a serving cell and/or an intermediate device belonging to a TAG associated with TAG identifier to be uplink time aligned. Therefore, the uplink transmission of the terminal equipment on different intermediate devices will not exceed the maximum uplink transmission time difference, which solves the problem that the network device is unable to provide sufficient bandwidths for the terminal equipment. In addition, the problem of inconsistency between the L1 synchronization/asynchronization states determined by a timer and the actual synchronization state of uplink transmission via intermediate device may be solved, thereby avoiding service interruption.

In some embodiments, serving cells and/or intermediate devices with identical time advance (TA) applicable uplinks (ULs) and using identical timing reference downlinks (DLs) are grouped in a timing advance group (TAG) or configured with identical TAG identifiers.

In the above embodiments, the timing advance group (TAG) includes at least one cell configured with uplink or at least one intermediate device configured with uplink.

In the above embodiment, if the intermediate device is associated with a primary cell, the TAG where the intermediate device is located is the primary TAG; otherwise, it is a secondary TAG.

For example, in a case where only one intermediate device is associated with the primary cell, the timing advance group (TAG) in which the intermediate device is located is a primary timing advance group (TAG).

For another example, in a case where at least two intermediate devices are associated with the primary cell, a timing advance group (TAG) in which a designated intermediate device in the two intermediate devices is located is the primary timing advance group (TAG), or a timing advance group (TAG) in which an intermediate device in at least two intermediate devices with a timing advance group (TAG) identifier being 0 is located is the primary timing advance group (TAG), or a timing advance group (TAG) in which a first intermediate device configured with the timing advance group (TAG) identifier in the at least two intermediate devices is located is the primary timing advance group (TAG).

In the above two examples, for non-shared frequency channel access, the primary timing advance group (TAG) may use a primary cell or an intermediate device associated with the primary cell as a timing reference; and for shared frequency channel access, the primary timing advance group (TAG) may use a primary cell or an intermediate device associated with the primary cell or a secondary cell or an intermediate device associated with the secondary cell as a timing reference.

For another example, in a case where the intermediate device is not associated with the primary cell, the timing advance group (TAG) where the intermediate device is located is a secondary timing advance group (TAG).

In this example, the secondary timing advance group (TAG) may use an active secondary cell therein or an intermediate device associated with the active secondary cell as a timing reference.

In the embodiment of this disclosure, the terminal equipment may use a timer corresponding to the timing advance group (TAG) to control how long a MAC entity considers a serving cell and/or an intermediate device belonging to a timing advance group (TAG) to be uplink time aligned.

In the above embodiment, the timer is used to indicate L1 synchronization or asynchronization/out of synchronization, for example, when the timer is running, it is considered as L1 synchronization; otherwise, it is considered as L1 out of synchronization. In the case of L1 out of synchronization, the uplink transmission can only be transmitted via MSG1/MSGA.

In some embodiments, when the terminal equipment receives a time advance command (TAC) media access control (MAC) control element (CE), and if a designated timing advance group (TAG) has already maintained a parameter N_{TA}, the media access control (MAC) entity will start or restart a timer associated with the designated timing advance group (TAG).

In some embodiments, when a timing advance command (TAC) is received in a random access response (RAR) message of a serving cell or an intermediate device belonging to a timing advance group (TAG) or in an MSG B of a specific cell or an intermediate device associated therewith,
if a random access preamble is not selected by a MAC entity from contention-based random access preambles, the MAC entity starts or restarts a timer associated with the timing advance group (TAG); otherwise, if the timer associated with the timing advance group (TAG) is not running, the MAC entity starts the timer associated with the timing advance group (TAG), and when a contention resolution is considered as being unsuccessful or after hybrid automatic repeat request (HARQ) feedback of an MAC PDU including UE contention resolution ID MAC CE is transmitted and when a contention resolution requested by system information (SI) is considered as being successful, the MAC entity stops the timer associated with the timing advance group (TAG); otherwise, the MAC entity ignores the received timing advance command (TAC).

In some embodiments, when the MAC entity stops uplink transmission of a secondary cell (SCell) and/or an intermediate device associated with the secondary cell due to that a maximum uplink transmission time difference between timing advance groups (TAGs) of the MAC entity is exceeded or a maximum uplink transmission time difference between timing advance groups (TAGs) of any MAC entity of the terminal equipment is exceeded, the MAC entity considers that a timer associated with the secondary cell and/or associated with the intermediate device associated with the secondary cell expires.

In the embodiment of this disclosure, in a case where the timer expires, if the timer is associated with a primary timing advance group (PTAG), the MAC entity may perform at least one of the following:
flushing all hybrid automatic repeat request (HARQ) buffers of all serving cells and all intermediate devices;
notifying a radio resource control (RRC) entity to release physical uplink control channels (PUCCHs) (if configured) of all serving cells and all intermediate devices;
notifying a radio resource control (RRC) entity to release sounding reference signals (SRSs) (if configured) of all serving cells and all intermediate devices;
clearing all configured downlink assignments and configured uplink grants;
clearing all physical uplink shared channel (PUSCH) resources for semi-persistent channel state information (CSI) reporting;
considering that all running time alignment timers expire; and
maintaining parameters N_{TA} of all timing advance groups (TAGs).

In the embodiment of this disclosure, in a case that the timer expires, if the timer is associated with a secondary timing advance group (STAG), for all serving cells and intermediate devices belonging to the timing advance group (TAG), the MAC entity may perform at least one of the following:
flushing all hybrid automatic repeat request (HARQ) buffers;
notifying a radio resource control (RRC) entity to release a physical uplink control channel (PUCCH) (if configured);
notifying a radio resource control (RRC) entity to release a sounding reference signal (SRS) (if configured);
clearing all configured downlink assignments and configured uplink grants;
clearing all physical uplink shared channel (PUSCH) resources for semi-persistent channel state information (CSI) reporting; and
maintaining the parameter N_{TA} of the timing advance group (TAG).

In the embodiment of this disclosure, the above timer may be an existing timer, namely, timeAlignmentTimer used in existing standards, or a newly introduced timer, which is, for example, referred to as T1. A method for configuring the newly introduced timer T1 is not limited in this disclosure, which may be configured by using a new domain or IE, similar to timeAlignmentTimer, or by using a choose structure. For example, it may be configured by using either the existing timeAlignmentTimer or T1, which shall not be described herein any further.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

According to the method of the embodiment of this disclosure, for the uplink transmission transmitted by the terminal via additional nodes/devices/entities with operating frequencies or deployment locations different from those of the network device, a separate uplink synchronization state is maintained, so as to avoid stop of uplink transmission due to that the UL transmission of the terminal at different additional nodes/devices/entities exceeds a maximum uplink transmission time difference, and avoid interference on the network device.

### Embodiment of a Second Aspect

The embodiment of this disclosure provides a method for maintenance of uplink time alignment, which shall be described from a network device. The embodiment of the second aspect is processing at the network device side corresponding to the embodiment of the first aspect, with contents identical to those in the embodiment of the first aspect being not going to be described herein any further.

FIG. 4 is a schematic diagram of the method for maintenance of uplink time alignment of the embodiment of this disclosure. As shown in FIG. 4, the method for maintenance of uplink time alignment of the embodiment of this disclosure includes:
401: a network device configures a timing advance group (TAG) identifier for a serving cell and/or an intermediate device (node/entity), the TAG identifier being used to acknowledge a timing advance group of a terminal equipment, wherein the terminal equipment uses a timer to control how long a media access control (MAC) entity considers a serving cell and/or an intermediate device belonging to a timing advance group (TAG) associated with the timer to be uplink time aligned.

It should be noted that FIG. 4 only schematically illustrates the embodiment of this disclosure; however, this disclosure is not limited thereto. For example, some other steps may be added, or some steps therein may be reduced. And appropriate variants may be made by those skilled in the art according to the above contents, without being limited to what is contained in FIG. 4.

In the above embodiment, contents regarding the terminal equipment have already been explained in the embodiment of the first aspect, and shall not be repeated herein any further.

In some embodiments, serving cells and/or intermediate devices with identical timing advance (TA) applicable uplinks (ULs) and using identical timing reference downlinks (DLs) are grouped in one timing advance group (TAG) or are configured with identical TAG identifiers.

In some embodiments, the timing advance group (TAG) includes at least one cell configured with uplink or at least one intermediate device configured with uplink.

In some embodiments, in a case where only one intermediate device is associated with a primary cell, a timing advance group (TAG) where the intermediate device is located is a primary timing advance group (TAG).

In some embodiments, in a case where at least two intermediate devices are associated with a primary cell, a timing advance group (TAG) where a designated intermediate device in the at least two intermediate devices is located is a primary timing advance group (TAG), or a timing advance group (TAG) where an intermediate device with a timing advance group (TAG) identifier being 0 in the at least two intermediate devices is located is a primary timing advance group (TAG), or a timing advance group (TAG) where a first intermediate device configured with a timing advance group (TAG) identifier in the at least two intermediate devices is located is a primary timing advance group (TAG).

In the above embodiment, for non-shared frequency channel access, the primary timing advance group (TAG) may use a primary cell or an intermediate device associated with the primary cell as a timing reference; and for shared frequency channel access, the primary timing advance group (TAG) may use a primary cell or an intermediate device associated with the primary cell or a secondary cell or an intermediate device associated with the secondary cell as a timing reference.

In some embodiments, in a case where the intermediate device is not associated with a primary cell, a timing advance group (TAG) where the intermediate device is located is a secondary timing advance group (TAG).

In the above embodiment, the secondary timing advance group (TAG) may use an activated secondary cell therein or an intermediate device associated with the activated secondary cell as a timing reference.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

According to the method of the embodiment of this disclosure, for the uplink transmission transmitted by the terminal via additional nodes/devices/entities with operating frequencies or deployment locations different from those of the network device, a separate uplink synchronization state is maintained, so as to avoid stop of uplink transmission due to that the UL transmission of the terminal at different additional nodes/devices/entities exceeds a maximum uplink transmission time difference, and avoid interference on the network device.

### Embodiment of a Third Aspect

The embodiment of this disclosure provides an apparatus for maintenance of uplink time alignment. The apparatus may be, for example, a terminal equipment, or one or some components or assemblies configured in the terminal equipment, with contents identical to those in the embodiment of the first aspect being not going to be described herein any further.

FIG. 5 is a schematic diagram of the apparatus for maintenance of uplink time alignment in the embodiment of this disclosure. As shown in FIG. 5, the apparatus 500 for maintenance of uplink time alignment includes:
a receiving unit 501 configured to receive configuration information of a timing advance group (TAG) identifier configured by a network device for a serving cell and/or an intermediate device (node/entity); and
a control unit 502 configured to control how long a MAC entity considers a serving cell and/or an intermediate device belonging to a timing advance group (TAG) associated with the timing advance group (TAG) identifier to be uplink time aligned.

In some embodiments, serving cells and/or intermediate devices with identical timing advance (TA) applicable uplinks (ULs) and using identical timing reference downlinks (DLs) are grouped in one timing advance group (TAG) or are configured with identical TAG identifiers.

In some embodiments, the timing advance group (TAG) includes at least one cell configured with an uplink or at least one intermediate device configured with an uplink.

In some embodiments, in a case where only one intermediate device is associated with a primary cell, a timing advance group (TAG) where the intermediate device is located is a primary timing advance group (TAG).

In some embodiments, in a case where at least two intermediate devices are associated with a primary cell, a timing advance group (TAG) where a designated intermediate device in the at least two intermediate devices is located is a primary timing advance group (TAG), or a timing advance group (TAG) where an intermediate device with a TAG identifier being 0 in the at least two intermediate devices is located is a primary timing advance group (TAG), or a timing advance group (TAG) where a first intermediate device configured with a timing advance group (TAG) identifier in the at least two intermediate devices is located is a primary timing advance group (TAG).

In the above embodiment, for non-shared frequency channel access, the primary timing advance group (TAG) uses a primary cell or an intermediate device associated with the primary cell as a timing reference; and for shared frequency channel access, the primary timing advance group (TAG) uses a primary cell or an intermediate device associated with the primary cell or a secondary cell or an intermediate device associated with the secondary cell as a timing reference.

In some embodiments, in a case where the intermediate device is not associated with a primary cell, the timing advance group (TAG) where the intermediate device is located is a secondary timing advance group (TAG).

In the above embodiment, the secondary timing advance group (TAG) uses an activated secondary cell therein or an intermediate device associated with the activated secondary cell as a timing reference.

In some embodiments, the control unit 502, by using a timer corresponding to the timing advance group (TAG), controls how long a media access control (MAC) entity considers a serving cell and/or an intermediate device belonging to a timing advance group (TAG) to be uplink time aligned.

In the above embodiment, when the terminal equipment receives a timing advance command (TAC) media access control (MAC) control element (CE), if a designated timing advance group (TAG) has maintained a parameter N_{TA}, the media access control (MAC) entity starts or restarts a timer associated with the designated timing advance group (TAG).

In the above embodiment, when a timing advance command (TAC) is received in a random access response (RAR) message of a serving cell or an intermediate device belonging to a timing advance group (TAG) or in an MSG B of a specific cell or an intermediate device associated therewith,
if a random access preamble is not selected by a MAC entity from contention-based random access preambles, the MAC entity will start or restart a timer associated with the timing advance group (TAG); otherwise, if the timer associated with the timing advance group (TAG) is not running, the MAC entity starts the timer associated with the timing advance group (TAG), and when a contention resolution is considered as being unsuccessful or after hybrid automatic repeat request (HARQ) feedback of an MAC PDU including UE contention resolution ID MAC CE is transmitted and when a contention resolution requested by system information (SI) is considered as being successful, the MAC entity stops the timer associated with the timing advance group (TAG); otherwise, the MAC entity ignores the received timing advance command (TAC).

In the above embodiment, when the MAC entity stops uplink transmission of a secondary cell (SCell) and/or an intermediate device associated with the secondary cell due to that a maximum uplink transmission time difference between timing advance groups (TAGs) of the MAC entity is exceeded or a maximum uplink transmission time difference between timing advance groups (TAGs) of any MAC entity of the terminal equipment is exceeded, the MAC entity considers that a timer associated with the secondary cell and/or associated with the intermediate device associated with the secondary cell expires.

In the above embodiment, in a case where the timer expires, if the timer is associated with a primary timing advance group (PTAG), the MAC entity performs at least one of the following:
flushing all hybrid automatic repeat request (HARQ) buffers of all serving cells and all intermediate devices;
notifying a radio resource control (RRC) entity to release physical uplink control channels (PUCCHs) of all serving cells and all intermediate devices;
notifying a radio resource control (RRC) entity to release sounding reference signals (SRSs) of all serving cells and all intermediate devices;
clearing all configured downlink assignments and configured uplink grants;
clearing all physical uplink shared channel (PUSCH) resources for semi-persistent channel state information (CSI) reporting;
considering that all running time alignment timers expire; and
maintaining parameters N_{TA} of all timing advance groups (TAGs).

In the above embodiment, in a case where the timer expires, if the timer is associated with a secondary timing advance group (STAG), for all serving cells and intermediate devices belonging to the timing advance group (TAG), the MAC entity performs at least one of the following:
flushing all hybrid automatic repeat request (HARQ) buffers;
notifying a radio resource control (RRC) entity to release a physical uplink control channel (PUCCH);
notifying a radio resource control (RRC) entity to release a sounding reference signal (SRS); clearing all configured downlink assignments and configured uplink grants;
clearing all physical uplink shared channel (PUSCH) resources for semi-persistent channel state information (CSI) reporting; and
maintaining the parameter N_{TA} of the timing advance group (TAG).

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the apparatus 500 for maintenance of uplink time alignment may further include other components or modules, and reference may be made to related techniques for particulars of these components or modules.

Furthermore, for the sake of simplicity, connection relationships between the components or modules or signal profiles thereof are only illustrated in FIG. 5. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

According to the method of the embodiment of this disclosure, for the uplink transmission transmitted by the terminal via additional nodes/devices/entities with operating frequencies or deployment locations different from those of the network device, a separate uplink synchronization state is maintained, so as to avoid stop of uplink transmission due to that the UL transmission of the terminal at different additional nodes/devices/entities exceeds a maximum uplink transmission time difference, and avoid interference on the network device.

### Embodiment of a Fourth Aspect

The embodiment of this disclosure provides an apparatus for maintenance of uplink time alignment. The apparatus may be, for example, a network device, or one or some components or assemblies configured in the network device, with contents identical to those in the embodiments of the first and second aspects being not going to be described herein any further.

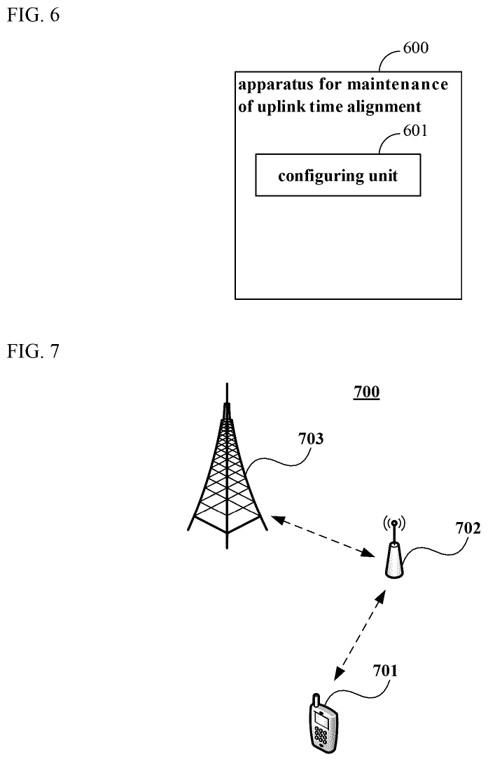

FIG. 6 is a schematic diagram of the apparatus for maintenance of uplink time alignment in the embodiment of this disclosure. As shown in FIG. 6, the apparatus 600 for maintenance of uplink time alignment includes:
a configuring unit 601 configured to configure a timing advance group (TAG) identifier for a serving cell and/or an intermediate device (node/entity), the TAG identifier being used to acknowledge a timing advance group of a terminal equipment;
wherein the terminal equipment uses a timer to control how long a media access control (MAC) entity considers a serving cell and/or an intermediate device belonging to a timing advance group (TAG) associated with the timer to be uplink time aligned.

In some embodiments, serving cells and/or intermediate devices with identical timing advance (TA) applicable uplinks (ULs) and using identical timing reference downlinks (DLs) are grouped in one timing advance group (TAG) or are configured with identical TAG identifiers.

In some embodiments, the timing advance group (TAG) includes at least one cell configured with an uplink or at least one intermediate device configured with an uplink.

In some embodiments, in a case where only one intermediate device is associated with a primary cell, a timing advance group (TAG) where the intermediate device is located is a primary timing advance group (TAG).

In some embodiments, in a case where at least two intermediate devices are associated with a primary cell, a timing advance group (TAG) where a designated intermediate device in the at least two intermediate devices is located is a primary timing advance group (TAG), or a timing advance group (TAG) where an intermediate device with a timing advance group (TAG) identifier being 0 in the at least two intermediate devices is located is a primary timing advance group (TAG), or a timing advance group (TAG) where a first intermediate device configured with a timing advance group (TAG) identifier in the at least two intermediate devices is located is a primary timing advance group (TAG).

In the above embodiment, for non-shared frequency channel access, the primary timing advance group (TAG) uses a primary cell or an intermediate device associated with the primary cell as a timing reference; and for shared frequency channel access, the primary timing advance group (TAG) uses a primary cell or an intermediate device associated with the primary cell or a secondary cell or an intermediate device associated with the secondary cell as a timing reference.

In some embodiments, in a case where the intermediate device is not associated with a primary cell, a timing advance group (TAG) where the intermediate device is located is a secondary timing advance group (TAG).

In the above embodiments, the secondary timing advance group (TAG) uses an activated secondary cell therein or an intermediate device associated with the activated secondary cell as a timing reference.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the apparatus 600 for maintenance of uplink time alignment may further include other components or modules, and reference may be made to related techniques for particulars of these components or modules.

Furthermore, for the sake of simplicity, connection relationships between the components or modules or signal profiles thereof are only illustrated in FIG. 6. However, it should be understood by those skilled in the art that such related techniques as bus connection, etc., may be adopted.

And the above components or modules may be implemented by hardware, such as a processor, a memory, a transmitter, and a receiver, etc., which are not limited in the embodiment of this disclosure.

According to the method of the embodiment of this disclosure, for the uplink transmission transmitted by the terminal via additional nodes/devices/entities with operating frequencies or deployment locations different from those of the network device, a separate uplink synchronization state is maintained, so as to avoid stop of uplink transmission due to that the UL transmission of the terminal at different additional nodes/devices/entities exceeds a maximum uplink transmission time difference, and avoid interference on the network device.

### Embodiment of a Fifth Aspect

The embodiment of this disclosure provides a communication system.

FIG. 7 is a schematic diagram of the communication system 700 of the embodiment of this disclosure.

In some embodiments, as shown in FIG. 7, the communication system 700 includes a terminal equipment 701, an intermediate device 702 and a network device 703.

In the embodiments of the disclosure, the terminal equipment 701 receives configuration information of a timing advance group (TAG) identifier configured by the network device 703 for a serving cell and/or an intermediate device (node/entity) 702, and controls how long a media access control (MAC) entity considers a serving cell and/or an intermediate device belonging to a timing advance group (TAG) associated with the timing advance group identifier to be uplink time aligned, and/or
the network device 703 configures a timing advance group (TAG) identifier for a serving cell and/or an intermediate device (node/entity) 702, the TAG identifier being used to acknowledge a timing advance group of a terminal equipment 701, and the terminal equipment 701 uses a timer to control how long a media access control (MAC) entity considers a serving cell and/or an intermediate device belonging to a timing advance group (TAG) associated with the timer to be uplink time aligned.

The embodiment of this disclosure further provides a terminal equipment.

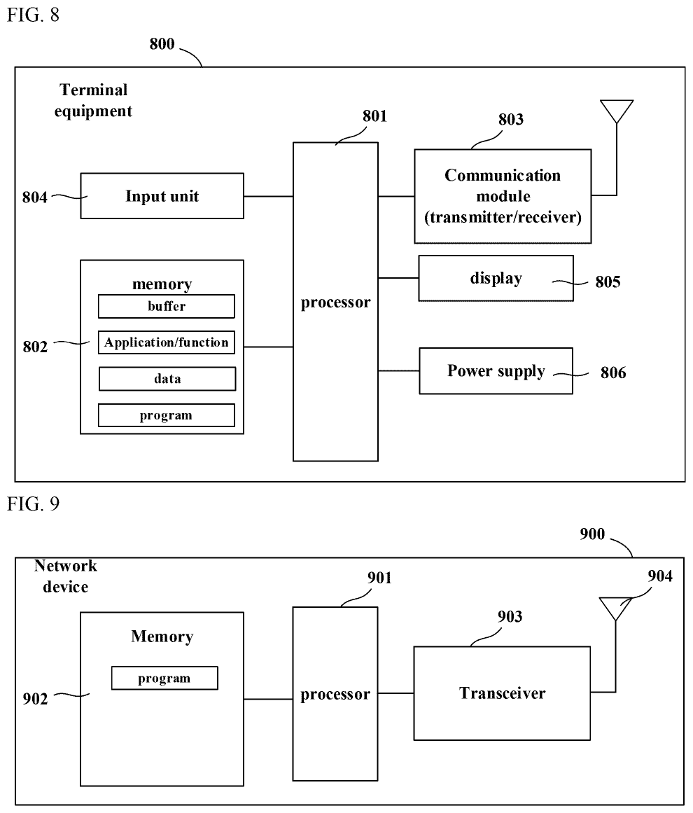

FIG. 8 is a schematic diagram of the terminal equipment of the embodiment of this disclosure. As shown in FIG. 8, the terminal equipment 800 may include a processor 801 and a memory 802, the memory 802 storing data and a program and being coupled to the processor 801. It should be noted that this figure is illustrative only, and other types of structures may also be used, so as to supplement or replace this structure and achieve a telecommunications function or other functions.

For example, the processor 801 may be configured to execute a program to carry out the method as described in the embodiment of the first aspect.

As shown in FIG. 8, the terminal equipment 800 may further include a communication module 803, an input unit 804, a display 805, and a power supply 806; wherein functions of the above components are similar to those in the related art, which shall not be described herein any further. It should be noted that the terminal equipment 800 does not necessarily include all the parts shown in FIG. 8, and the above components are not necessary. Furthermore, the terminal equipment 800 may include parts not shown in FIG. 8, and the related art may be referred to.

The embodiment of this disclosure further provides a network device.

FIG. 9 is a schematic diagram of the network device of the embodiment of this disclosure. As shown in FIG. 9, the network device 900 may include a processor 901 (such as a central processing unit (CPU)) and a memory 902, the memory 902 being coupled to the processor 901. Wherein, the memory 902 may store various data, and furthermore, it may store a program for information processing, and execute the program under control of the processor 901.

For example, the processor 901 may be configured to execute a program to carry out the method described in the embodiment of the second aspect.

Furthermore, as shown in FIG. 9, the network device 900 may include a transceiver 903, and an antenna 904, etc., wherein, functions of the above components are similar to those in the related art, and shall not be described herein any further. It should be noted that the network device 900 does not necessarily include all the parts shown in FIG. 9, and furthermore, the network device 900 may include parts not shown in FIG. 9, and the related art may be referred to.

An embodiment of this disclosure provides a computer readable program, which, when executed in a terminal equipment, will cause the terminal equipment to carry out the method as described in the embodiment of the first aspect.

An embodiment of this disclosure provides a storage medium storing a computer readable program, which will cause a terminal equipment to carry out the method as described in the embodiment of the first aspect.

An embodiment of this disclosure provides a computer readable program, which, when executed in a network device, will cause the network device to carry out the method as described in the embodiment of the second aspect.

An embodiment of this disclosure provides a storage medium storing a computer readable program, which will cause a network device to carry out the method as described in the embodiment of the second aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

As to implementations containing the above embodiments, following supplements are further disclosed.

1. A method for maintenance of uplink time alignment, including:
receiving, by a terminal equipment, configuration information of a timing advance group (TAG) identifier configured by a network device for a serving cell and/or an intermediate device (node/entity); and
controlling by the terminal equipment how long a media access control (MAC) entity considers a serving cell and/or the intermediate device belonging to a timing advance group (TAG) associated with the timing advance group identifier to be uplink time aligned.

2. The method according to supplement 1, wherein serving cells and/or intermediate devices with identical timing advance (TA) applicable uplinks (ULs) and using identical timing reference downlinks (DLs) are grouped in one timing advance group (TAG) or are configured with identical TAG identifiers.

3. The method according to supplement 1 or 2, wherein the timing advance group (TAG) includes at least one cell configured with an uplink or at least one intermediate device configured with an uplink.

4. The method according to any one of supplements 1-3, wherein,
in a case where only one intermediate device is associated with a primary cell, a timing advance group (TAG) where the intermediate device is located is a primary timing advance group (TAG);
and in a case where at least two intermediate devices are associated with a primary cell, a timing advance group (TAG) where a designated intermediate device in the at least two intermediate devices is located is a primary timing advance group (TAG), or a timing advance group (TAG) where an intermediate device with a TAG identifier being 0 in the at least two intermediate devices is located is a primary timing advance group (TAG), or a timing advance group (TAG) where a first intermediate device configured with a timing advance group (TAG) identifier in the at least two intermediate devices is located is a primary timing advance group (TAG).

5. The method according to supplement 4, wherein,
for non-shared frequency channel access, the primary timing advance group (TAG) uses a primary cell or an intermediate device associated with the primary cell as a timing reference;
and for shared frequency channel access, the primary timing advance group (TAG) uses a primary cell or an intermediate device associated with the primary cell or a secondary cell or an intermediate device associated with the secondary cell as a timing reference.

6. The method according to any one of supplements 1-3, wherein,
in a case where the intermediate device is not associated with a primary cell, the timing advance group (TAG) where the intermediate device is located is a secondary timing advance group (TAG).

7. The method according to supplement 6, wherein the secondary timing advance group (TAG) uses an activated secondary cell therein or an intermediate device associated with the activated secondary cell as a timing reference.

8. The method according to any one of supplements 1-7, wherein by using a timer corresponding to the timing advance group (TAG), the terminal equipment controls how long a media access control (MAC) entity considers a serving cell and/or an intermediate device belonging to a timing advance group (TAG) to be uplink time aligned.

9. The method according to supplement 8, wherein when the terminal equipment receives a timing advance command (TAC) media access control (MAC) control element (CE), if a designated timing advance group (TAG) has maintained a parameter N_{TA}, the media access control (MAC) entity starts or restarts a timer associated with the designated timing advance group (TAG).

10. The method according to supplement 8 or 9, wherein when a timing advance command (TAC) is received in a random access response (RAR) message of a serving cell or an intermediate device belonging to a timing advance group (TAG) or in an MSG B of a specific cell or an intermediate device associated therewith,
if a random access preamble is not selected by a MAC entity from contention-based random access preambles, the MAC entity starts or restarts a timer associated with the timing advance group (TAG); otherwise, if the timer associated with the timing advance group (TAG) is not running, the MAC entity starts the timer associated with the timing advance group (TAG), and when a contention resolution is considered as being unsuccessful or after hybrid automatic repeat request (HARQ) feedback of an MAC PDU including UE contention resolution ID MAC CE is transmitted and when a contention resolution requested by system information (SI) is considered as being successful, the MAC entity stops the timer associated with the timing advance group (TAG); otherwise, the MAC entity ignores the received timing advance command (TAC).

11. The method according to any one of supplements 8-10, wherein when the MAC entity stops uplink transmission of a secondary cell (SCell) and/or an intermediate device associated with the secondary cell due to that a maximum uplink transmission time difference between timing advance groups (TAGs) of the MAC entity is exceeded or a maximum uplink transmission time difference between timing advance groups (TAGs) of any MAC entity of the terminal equipment is exceeded, the MAC entity considers that a timer associated with the secondary cell and/or associated with the intermediate device associated with the secondary cell expires.

12. The method according any one of supplements 8-11, wherein in a case where the timer expires, if the timer is associated with a primary timing advance group (PTAG), the MAC entity performs at least one of the following:
flushing all hybrid automatic repeat request (HARQ) buffers of all serving cells and all intermediate devices;
notifying a radio resource control (RRC) entity to release physical uplink control channels (PUCCHs) of all serving cells and all intermediate devices;
notifying a radio resource control (RRC) entity to release sounding reference signals (SRSs) of all serving cells and all intermediate devices;
clearing all configured downlink assignments and configured uplink grants;
clearing all physical uplink shared channel (PUSCH) resources for semi-persistent channel state information (CSI) reporting;
considering that all running time alignment timers expire; and
maintaining parameters N_{TA} of all timing advance groups (TAGs).

13. The method according to any one of supplements 8-12, wherein in a case that the timer expires, if the timer is associated with a secondary timing advance group (STAG), for all serving cells and intermediate devices belonging to the timing advance group (TAG), the MAC entity performs at least one of the following:
flushing all hybrid automatic repeat request (HARQ) buffers;
notifying a radio resource control (RRC) entity to release a physical uplink control channel (PUCCH);
notifying a radio resource control (RRC) entity to release a sounding reference signal (SRS); clearing all configured downlink assignments and configured uplink grants;
clearing all physical uplink shared channel (PUSCH) resources for semi-persistent channel state information (CSI) reporting; and
maintaining the parameter N_{TA} of the timing advance group (TAG).

14. A method for maintenance of uplink time alignment, including:
configuring a timing advance group (TAG) identifier by a network device for a serving cell and/or an intermediate device (node/entity), the TAG identifier being used to acknowledge a timing advance group of a terminal equipment;
wherein the terminal equipment uses a timer to control how long a media access control (MAC) entity considers a serving cell and/or an intermediate device belonging to a timing advance group (TAG) associated with the timer to be uplink time aligned.

15. The method according to supplement 14, wherein serving cells and/or intermediate devices with identical timing advance (TA) applicable uplinks (ULs) and using identical timing reference downlinks (DLs) are grouped in one timing advance group (TAG) or are configured with identical TAG identifiers.

16. The method according to supplement 14 or 15, wherein the timing advance group (TAG) includes at least one cell configured with uplink or at least one intermediate device configured with uplink.

17. The method according to any one of supplements 14-16, wherein, in a case where only one intermediate device is associated with a primary cell, a timing advance group (TAG) where the intermediate device is located is a primary timing advance group (TAG);
and in a case where at least two intermediate devices are associated with a primary cell, a timing advance group (TAG) where a designated intermediate device in the at least two intermediate devices is located is a primary timing advance group (TAG), or a timing advance group (TAG) where an intermediate device with a timing advance group (TAG) identifier being 0 in the at least two intermediate devices is located is a primary timing advance group (TAG), or a timing advance group (TAG) where a first intermediate device configured with a timing advance group (TAG) identifier in the at least two intermediate devices is located is a primary timing advance group (TAG).

18. The method according to supplement 17, wherein,
for non-shared frequency channel access, the primary timing advance group (TAG) uses a primary cell or an intermediate device associated with the primary cell as a timing reference;
and for shared frequency channel access, the primary timing advance group (TAG) uses a primary cell or an intermediate device associated with the primary cell or a secondary cell or an intermediate device associated with the secondary cell as a timing reference.

19. The method according to any one of supplements 14-16, wherein in a case where the intermediate device is not associated with a primary cell, a timing advance group (TAG) where the intermediate device is located is a secondary timing advance group (TAG).

20. The method according to supplement 19, wherein the secondary timing advance group (TAG) uses an activated secondary cell therein or an intermediate device associated with the activated secondary cell as a timing reference.

21. A terminal equipment, including a memory and a processor, the memory storing a computer program, and the processor being configured to execute the computer program to carry out the method as described in any one of supplements 1-13.

22. A network device, including a memory and a processor, the memory storing a computer program, and the processor being configured to execute the computer program to carry out the method as described in any one of supplements 14-20.

23. A communication system, including a terminal equipment, an intermediate device and a network device, wherein,
the terminal equipment receives configuration information of a timing advance group (TAG) identifier configured by the network device for a serving cell and/or an intermediate device (node/entity), and controls how long a media access control (MAC) entity considers a serving cell and/or an intermediate device belonging to a timing advance group (TAG) associated with the timing advance group identifier to be uplink time aligned, and/or
the network device configures a timing advance group (TAG) identifier for a serving cell and/or an intermediate device (node/entity), the TAG identifier being used to acknowledge a timing advance group of a terminal equipment, and the terminal equipment uses a timer to control how long a media access control (MAC) entity considers a serving cell and/or an intermediate device belonging to a timing advance group (TAG) associated with the timer to be uplink time aligned.

1. An apparatus for maintenance of uplink time alignment, configured in a terminal equipment, the apparatus comprising:
a receiver configured to receive configuration information of a timing advance group (TAG) identifier configured by a network device for an intermediate device being a TRP of a serving cell for inter-cell or intra-cell multi-DCI multi-TRP operation; and
a processor configured to control how long a MAC entity considers serving cells to a timing advance group (TAG) associated with the configured timing advance group identifier to be uplink time aligned for the TAG.

2. The apparatus according to claim 1, wherein serving cells and/or intermediate devices with identical timing advance (TA) applicable uplinks (ULs) and using identical timing reference downlinks (DLs) are grouped in one timing advance group (TAG) or are configured with identical TAG identifiers.

3. The apparatus according to claim 1, wherein the timing advance group (TAG) includes at least one cell configured with an uplink or at least one intermediate device configured with an uplink.

4. The apparatus according to claim 1, wherein,
in a case where only one intermediate device is associated with a primary cell, a timing advance group (TAG) where the intermediate device is located is a primary timing advance group (TAG);
and in a case where at least two intermediate devices are associated with a primary cell, a timing advance group (TAG) where a designated intermediate device in the at least two intermediate devices is located is a primary timing advance group (TAG), or a timing advance group (TAG) where an intermediate device with a timing advance group (TAG) identifier being 0 in the at least two intermediate devices is located is a primary timing advance group (TAG), or a timing advance group (TAG) where a first intermediate device configured with a timing advance group (TAG) identifier in the at least two intermediate devices is located is a primary timing advance group (TAG).

5. The apparatus according to claim 4, wherein,
for non-shared frequency channel access, the primary timing advance group (TAG) uses a primary cell or an intermediate device associated with the primary cell as a timing reference;
and for shared frequency channel access, the primary timing advance group (TAG) uses a primary cell or an intermediate device associated with the primary cell or a secondary cell or an intermediate device associated with the secondary cell as a timing reference.

6. The apparatus according to claim 1, wherein, in a case where the intermediate device is not associated with a primary cell, the timing advance group (TAG) where the intermediate device is located is a secondary timing advance group (TAG).

7. The apparatus according to claim 6, wherein the secondary timing advance group (TAG) uses an activated secondary cell therein or an intermediate device associated with the activated secondary cell as a timing reference.

8. The apparatus according to claim 1, wherein the processor, by using a timer corresponding to the timing advance group (TAG), controls how long a media access control (MAC) entity considers serving cells to the timing advance group (TAG) to be uplink time aligned for the TAG.

9. The apparatus according to claim 8, wherein, further comprises,
a transmitter,
when the timer is not running, it is considered that L1 is not synchronized, and the transmitter only transmits message 1 and message A of the TAG for which the timer is not running.

10. The apparatus according to claim 8, wherein when the terminal equipment receives a timing advance command (TAC) media access control (MAC) control element (CE), if a designated timing advance group (TAG) has maintained a parameter N_{TA}, the media access control (MAC) entity starts or restarts a timer associated with the designated timing advance group (TAG).

11. The apparatus according to claim 8, wherein when a timing advance command (TAC) is received in a random access response (RAR) message of a serving cell or an intermediate device belonging to a timing advance group (TAG) or in an MSG B of a specific cell or an intermediate device associated therewith,
if a random access preamble is not selected by a MAC entity from contention-based random access preambles, the MAC entity starts or restarts the timer associated with the timing advance group (TAG); otherwise, if the timer associated with the timing advance group (TAG) is not running, the MAC entity starts the timer associated with the timing advance group (TAG), and when a contention resolution is considered as being unsuccessful or after hybrid automatic repeat request (HARQ) feedback of an MAC PDU including UE contention resolution ID MAC CE is transmitted and when a contention resolution requested by system information (SI) is considered as being successful, the MAC entity stops the timer associated with the timing advance group (TAG); otherwise, the MAC entity ignores the received timing advance command (TAC).

12. The apparatus according to claim 8, wherein when the MAC entity stops uplink transmission of a secondary cell (SCell) configured with two TAGs due to the fact that a maximum uplink transmission time difference between timing advance groups (TAGs) of the MAC entity or a maximum uplink transmission time difference between timing advance groups (TAGs) of any MAC entity of the terminal equipment is exceeded, the MAC entity considers that a timer associated with the TAG expires.

13. The apparatus according to claim 8, wherein in a case where the timer expires, if the timer is associated with a primary timing advance group (PTAG), the MAC entity performs at least one of the following:
flushing all hybrid automatic repeat request (HARQ) buffers of all serving cells and all intermediate devices;
notifying a radio resource control (RRC) entity to release physical uplink control channels (PUCCHs) of all serving cells and all intermediate devices;
notifying a radio resource control (RRC) entity to release sounding reference signals (SRSs) of all serving cells and all intermediate devices;
clearing all configured downlink assignments and configured uplink grants;
clearing all physical uplink shared channel (PUSCH) resources for semi-persistent channel state information (CSI) reporting;
considering that all running time alignment timers expire; and
maintaining parameters N_{TA} of all timing advance groups (TAGs).

14. The apparatus according to claim 8, wherein in a case that the timer expires, if the timer is associated with a secondary timing advance group (STAG), for all serving cells configured with the two timing advance groups (TAGs), the MAC entity performs:
clearing any configured downlink assignments and configured uplink grants associate with TAG of the expired timer;
clearing any physical uplink shared channel (PUSCH) resources for semi-persistent channel state information (CSI) reporting associate with the TAG of the expired timer; and
maintaining the parameter N_{TA} of the timing advance group (TAG) of the expired timer.

15. An apparatus for maintenance of uplink time alignment, configured in a network device, apparatus comprising:
a processor configured to configure a timing advance group (TAG) identifier for an intermediate device being a TRP of a serving cell for inter-cell or intra-cell multi-DCI multi-TRP operation, the TAG identifier being used to acknowledge a timing advance group of a terminal equipment;
wherein the terminal equipment uses a timer to control how long a media access control (MAC) entity considers serving cells to a timing advance group (TAG) associated with the timer to be uplink time aligned for the TAG.

16. The apparatus according to claim 15, wherein the intermediate devices with identical timing advance (TA) applicable uplinks (ULs) and using identical timing reference downlinks (DLs) are grouped in one timing advance group (TAG) or are configured with identical TAG identifiers.

17. The apparatus according to claim 15, wherein,
in a case where only one intermediate device is associated with a primary cell, a timing advance group (TAG) where the intermediate device is located is a primary timing advance group (TAG);
and in a case where at least two intermediate devices are associated with a primary cell, a timing advance group (TAG) where a designated intermediate device in the at least two intermediate devices is located is a primary timing advance group (TAG), or a timing advance group (TAG) where an intermediate device with a timing advance group (TAG) identifier being 0 in the at least two intermediate devices is located is a primary timing advance group (TAG), or a timing advance group (TAG) where a first intermediate device configured with a timing advance group (TAG) identifier in the at least two intermediate devices is located is a primary timing advance group (TAG).

18. The apparatus according to claim 15, wherein in a case where the intermediate device is not associated with a primary cell, a timing advance group (TAG) where the intermediate device is located is a secondary timing advance group (TAG).

19. The apparatus according to claim 18, wherein the secondary timing advance group (TAG) uses an activated secondary cell therein or an intermediate device associated with the activated secondary cell as a timing reference.

20. A communication system, comprising:
a terminal equipment;
an intermediate device; and
a network device, wherein,
the terminal equipment receives configuration information of a timing advance group (TAG) identifier configured by the network device for the intermediate device, and controls how long a media access control (MAC) entity considers serving cells to a timing advance group (TAG) associated with the timing advance group identifier to be uplink time aligned for the TAG, and/or
the network device configures a timing advance group (TAG) identifier for the intermediate device, the TAG identifier being used to acknowledge a timing advance group of a terminal equipment, and the terminal equipment uses a timer to control how long a media access control (MAC) entity considers serving cells to a timing advance group (TAG) associated with the timer to be uplink time aligned for the TAG,
wherein, the intermediate device is a TRP for inter-cell or intra-cell multi-DCI multi-TRP operation.
